(19) United States
(12) Patent Application Publication
(10) Pub. No.: US 2011/0133675 A1
(43) Pub. Date: Jun. 9, 2011

(54) ILLUMINATION DEVICE

(76) Inventor: Maurice DiGregorio, Webster, MA (US)

(21) Appl. No.: 12/632,999

(22) Filed: Dec. 8, 2009

(51) Int. Cl. H05B 37/02; F21L 4/00

(52) U.S. Cl. 315/362; 362/157

(57) ABSTRACT

An illumination device suitable for attachment to factory remote controls, wherein the illumination device further comprises a locator accessory.

### FIELD OF THE INVENTION

The present invention generally relates to an illumination device which is suitable for attachment to a remote control.

The present invention also generally relates to a remote control unit comprising a remote control and an illumination device attached to the remote control.

### BACKGROUND OF THE INVENTION

Users of televisions, stereo systems, video cassette recorders, digital video recorders, and other media devices frequently use these devices in dark or dimly lit rooms. The remote controls which are paired with these devices can be complex, and when a user has multiple remote controls for multiple media devices, it can be difficult to remember the function of all the remote control buttons. However, it can be inconvenient to use an external light to illuminate a remote control. Furthermore, remote control illumination sources in the art are large and add significant bulk to the remote control itself.

Universal remote controls are available and some have an internal or external illumination source, which allows a user to view the remote control buttons in a dark or dimly lit room. However, these universal remote controls are not designed to be used with one specific media device; therefore they frequently have too many or too few buttons, which adds to a user's confusion. Factory remote controls, or those which are specific to the accompanying media device when the media device is sold at retail, are frequently easier to learn and use, although they lack an illumination source characteristic of some universal remote controls.

Users also frequently lose remote controls. As small, portable devices, remote controls can be easily dropped, moved, or inadvertently hidden.

Therefore, it would be advantageous to provide an illumination device suitable for attachment to a factory remote control, wherein the illumination device also comprises a locator accessory.

### SUMMARY OF THE INVENTION

Among the various aspects of the present invention is the provision of an illumination device suitable for attachment to a remote control.

Briefly, therefore, the present invention is directed to an illumination device comprising a housing, a magnetic panel, and a flexible cord attaching the housing to the magnetic panel. The present invention is further directed to an illumination device comprising a locator accessory.

Other objects and features will be in part apparent and in part pointed out hereinafter.

### BRIEF DESCRIPTION OF THE DRAWINGS

FIG. 1 shows an embodiment of an illumination device, specifically the top side of a magnetic panel attached to a housing via a flexible cord.

FIG. 2 shows a bottom side of a magnetic panel, with a hook and loop fastener for attaching the magnetic panel to a remote control.

FIG. 3 shows an embodiment of a housing, with an activation switch and an illumination source.

FIG. 4 shows an embodiment of an illumination device, specifically the top side of a magnetic panel attached to a housing via a flexible cord.

FIG. 5 shows an embodiment of a housing, with an activation switch, an illumination source, and a portion of the housing which is magnetic.

FIG. 6 shows a schematic of the inside of a housing embodiment.

### DETAILED DESCRIPTION OF THE INVENTION

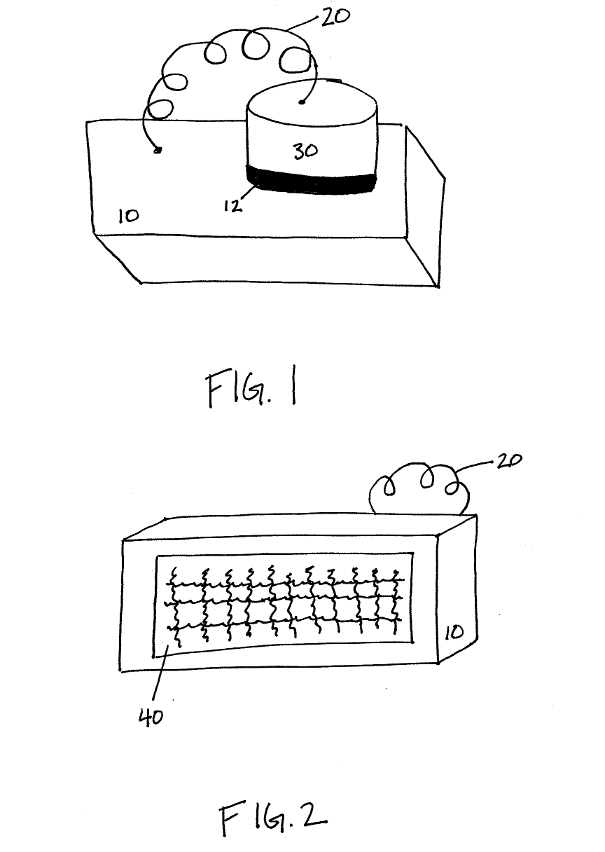

Referring to the drawings, FIGS. 1 and 4 show an embodiment of the illumination device. The illumination device comprises a magnetic panel, 10, which is capable of being attached to a remote control. In one embodiment, the bottom side of the magnetic panel may be capable of being attached to a remote control, as shown in an embodiment in FIG. 2, so the magnetic panel is appropriately attached to the top surface of a remote control. In another embodiment, the top surface of the magnetic panel may be capable of being attached to a remote control, such that the magnetic panel is attached to the bottom surface of a remote control, as shown in an embodiment in FIG. 4.

The magnetic panel may be attached to the remote control in various ways. For example, FIG. 2 shows hook and loop fastener, such as Velcro®, 40, on the bottom side of the magnetic panel. Additionally, the magnetic panel may be attached to the remote control using an adhesive such as tape, including double-sided tape, or a chemical bonding agent such as glue. In further embodiments, the magnetic panel may be physically attached to the remote control, such as with a clamp or clip. In one exemplary embodiment, the magnetic panel itself is the clamp or clip. In an alternate embodiment, the magnetic panel is attached to the remote control with a strap or elastic band.

In one embodiment, the illumination device is permanently attached to the remote control. In another embodiment, the illumination device is releasably attached to a remote control, allowing the illumination device to be detached from the remote control at the convenience of the user. The magnetic panel may be attached to any surface of a remote control, including the top surface, the bottom surface, or even the side of the remote control, as the user prefers.

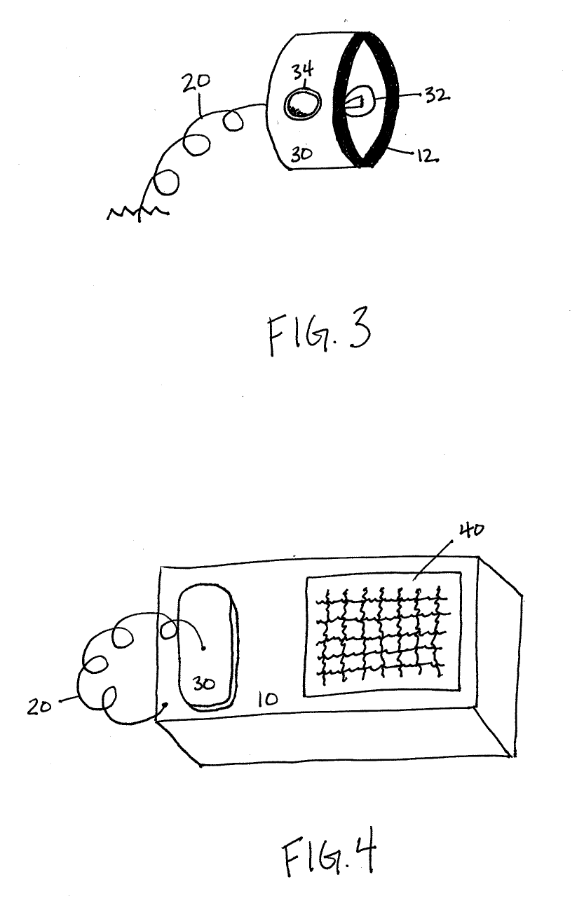

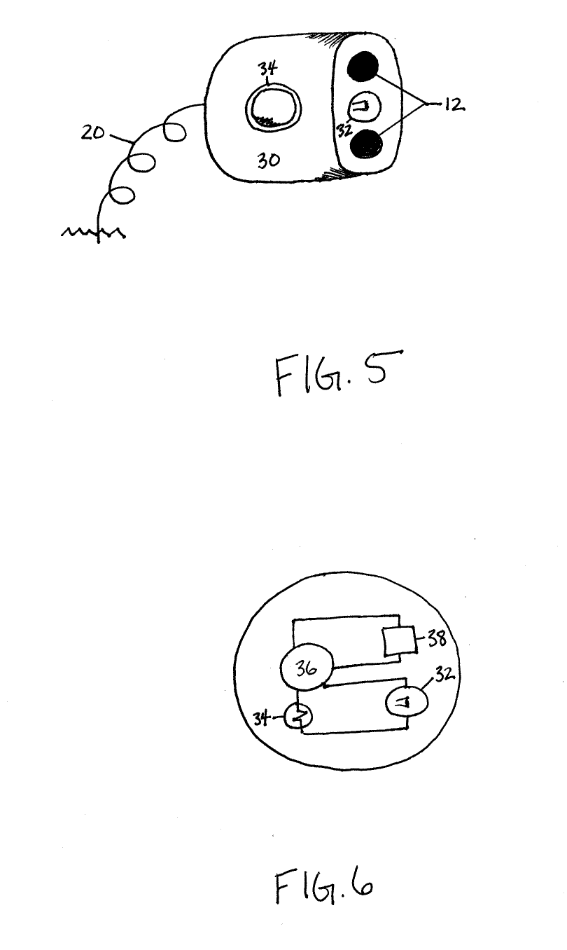

The illumination device further comprises a housing, 30, wherein at least a portion of the housing is magnetic. The magnetic portion of the housing, 12, is magnetically attachable to the magnetic panel. This allows the housing to rest safely and securely on the magnetic panel when not in use. In an embodiment, the magnetic portion of the housing may be one or more magnets affixed to a surface of the housing, as shown in FIG. 5. In an alternate embodiment, the magnetic portion of the housing is integrated into the housing itself, as shown in FIGS. 1 and 3.

The housing, 30, further comprises an illumination source, 32. In a preferred embodiment, the illumination source is a light bulb. The light bulb can be, for example without limitation, an incandescent light bulb, a halogen light bulb, a fluorescent light bulb, or a light emitting diode (LED). The light bulb is illuminated using power from the power source.

The housing, 30, further comprises a power source, 36. In an embodiment shown in FIG. 6, the power source is entirely enclosed within the housing. In an embodiment, the power source is an electrochemical power source, for example, a battery. In a further embodiment, the battery is permanently contained entirely within the housing. In an alternate embodiment, the battery, upon depletion, can be removed and exchanged for a fresh battery. The power source provides electric power to the illumination source. The power source may further provide electric power to the locator accessory.

The housing, 30, further comprises an activation switch, 34. The activation switch causes the illumination source to turn on and off. In one embodiment, the activation switch may cause the illumination source to turn either off or on, as appropriate, depending on the current status of the illumination source. In another embodiment, the illumination source remains on while the activation switch is depressed, and when the activation switch is released and returned to its ordinary position, the illumination source turns and remains off.

The housing, 30, further comprises a locator accessory. In one embodiment, the locator accessory is paired with a corresponding locating unit, which is physically separate and unattached from the locator accessory and the housing. When the locating unit is activated, the locator accessory alerts the user to the location of the housing. In one embodiment, when the locating unit is activated, the locator accessory vibrates. In another embodiment, when the locating unit is activated, the locator accessory emits a sound. In a further embodiment, when the locating unit is activated, the locator accessory causes the illumination source to turn on.

The illumination source, the power source, the activation switch, and the locator accessory may be contained within the housing as shown in FIG. 6. Within the housing, the power source, 36, is electrically connected to the illumination source, 32. The power source is further electrically connected to the locator accessory, 38. In an embodiment where the locator accessory, upon activation of the locating unit, causes the illumination source to turn on, the locator accessory is electrically connected to the illumination source. The activation switch, 34, is also electrically connected to the illumination source.

The housing, 30, is connected to the magnetic panel, 10, by a flexible cord, 20, which is affixed to the magnetic panel and the housing. The flexible cord allows the housing to be freely rotated with respect to the magnetic panel, such that the illumination source can be directed in any direction. For example, when the magnetic panel is attached to a remote control, the flexible cord allows the user to direct the illumination source to the keys on said remote control, or reading material next to a remote control, or anywhere otherwise convenient for the user. In an embodiment, the flexible cord is a coiled cord. In a further embodiment, the flexible cord is a coiled plastic cord. In another embodiment, the flexible cord is comprised of string. In a further embodiment, the flexible cord is a wire. In an alternate embodiment, the flexible cord is retractable.

The invention also comprises, in certain embodiments, an illumination remote control unit, comprising an illumination device as described, attached to a remote control. In a preferred embodiment, the remote control is a factory remote control; specifically, in this preferred embodiment, the remote control is designed to operate a specific media device, such as a television, recorder, or stereo system, or even a specific model or type of television, recorder, or stereo system. In another preferred embodiment, the illumination device comprises a magnetic panel which is attached to the remote control and a flexible cord which attaches a housing to the magnetic panel, wherein at least a portion of the housing is magnetic. In a further preferred embodiment, the housing is magnetically attachable to the magnetic panel. In another embodiment, the housing comprises an illumination source, a power source, an activation switch, and a locator accessory.

Having described the invention in detail, it will be apparent that modifications and variations are possible without departing the scope of the invention defined in the appended claims. Furthermore, it should be appreciated that all examples in the present disclosure are provided as non-limiting examples.

What is claimed is:

1. An illumination device suitable for attachment to a remote control, comprising:
a housing wherein at least a portion of the housing is magnetic and wherein the housing comprises an illumination source, a power source, an activation switch, and a locator accessory;
a magnetic panel capable of being attached to the remote control; and
a flexible cord attaching the housing to the magnetic panel, wherein the flexible cord allows the illumination source to be directed in any direction without changing the orientation of the magnetic panel;
wherein the magnetic portion of the housing is magnetically attachable to the magnetic panel.

2. The illumination device of claim 1, wherein the magnetic panel is capable of being attached to the remote control with hook-and-loop fastener, tape, glue, a clip, a clamp, a strap, or an elastic band.

3. The illumination device of claim 1, wherein the illumination source is a light bulb.

4. The illumination device of claim 1, wherein the power source is a battery.

5. The illumination device of claim 1, wherein the activation switch turns the illumination source on and off.

6. The illumination device of claim 1, wherein the locator accessory has a separate, unattached corresponding locating unit, which, when activated, causes the locator accessory to emit a noise.

7. The illumination device of claim 1, wherein the locator accessory has a separate, unattached corresponding locating unit, which, when activated, causes the locator accessory to vibrate.

8. The illumination device of claim 1, wherein the locator accessory has a separate, unattached corresponding locating unit, which, when activated, causes the locator accessory to turn the illumination source on.

9. The illumination device of claim 1, wherein the illumination device is releasably attached to a remote control.

10. The illumination device of claim 1, wherein the illumination device is permanently attached to a remote control.
